(19) United States
(12) Patent Application Publication
(10) Pub. No.: US 2022/0075830 A1
(43) Pub. Date: Mar. 10, 2022

(54) RESUMABLE ORDERED RECURSIVE TRAVERSAL OF AN UNORDERED DIRECTORY TREE

(71) Applicant: EMC IP Holding Company LLC, Hopkinton, MA (US)

(72) Inventors: Peter Van Sandt, Seattle, WA (US); Dipankar Roy, San Jose, CA (US); Takafumi Yonekura, Bellevue, WA (US)

(21) Appl. No.: 17/017,140

(22) Filed: Sep. 10, 2020

(51) Int. Cl. G06F 16/903; G06F 16/901; G06F 9/48

(52) U.S. Cl. CPC G06F 16/90348; G06F 9/4881; G06F 16/9027; G06F 16/9017

(57) ABSTRACT

Described herein are technologies directed to resumable ordered recursive traversal of an unordered directory tree. Using the techniques described herein, a lexicographic listing of stored objects can be efficiently built from a directory tree that is not lexicographically ordered. Furthermore, the techniques provided herein can output an initial partial lexicographic listing of stored objects having a start location and an end location, and later resumed to output a subsequent lexicographic listing of stored objects which begins after the end location.

### TECHNICAL FIELD

The subject disclosure relates generally to electronic data storage systems. More particularly, the subject disclosure relates to storage and retrieval of data by server storage systems, such as cloud servers and server clusters.

### BACKGROUND

Today's network computing architectures support storage of large numbers of objects at server devices and anytime, anywhere access to the objects by client devices with appropriate credentials. A variety of technologies support object storage and retrieval, as well as related security and administrative functions.

Some administrative functions can support inspection of objects stored on behalf of a client. For example, objects may be stored in a directory tree or other organizational structure at the server(s), and an authorized administrator or application can be allowed to inspect the directory tree. While inspecting objects stored at the server is useful, further utility can be gained by re-organizing stored objects, or at least re-organizing object identification information, and supporting inspection of the re-organized objects or object identification information.

The above-described background is merely intended to provide a contextual overview of some current issues and is not intended to be exhaustive. Other contextual information may become further apparent upon review of the following detailed description.

### BRIEF DESCRIPTION OF THE DRAWINGS

FIG. 1 illustrates an example cluster of computing devices, in accordance with one or more embodiments described herein.

FIG. 2 illustrates an example client and server coupled via a network, in accordance with one or more embodiments described herein.

FIG. 3 illustrates an example object storage comprising an example directory tree, in accordance with one or more embodiments described herein.

FIG. 4 illustrates example interactions between a client device, a server device and an object storage, in accordance with one or more embodiments described herein.

FIG. 5 illustrates example operations of a server device to build an ordered list, in accordance with one or more embodiments described herein.

FIG. 6 illustrates example inputs and outputs of an ordered list builder, in accordance with one or more embodiments described herein.

FIG. 7 is a flow diagram of an example, non-limiting computer implemented method for a server device to build an ordered list of objects from an unordered directory tree, in accordance with one or more embodiments described herein.

FIG. 8 is a flow diagram of an example, non-limiting computer implemented method for a client device to request an ordered list of objects from a server which stores the objects in an unordered directory tree, in accordance with one or more embodiments described herein.

FIG. 9 is a flow diagram of another example, non-limiting computer implemented method for a server device to build an ordered list of objects from an unordered directory tree, in accordance with one or more embodiments described herein.

FIG. 10 illustrates a block diagram of an example computer operable to provide any of the various devices described herein.

### DETAILED DESCRIPTION

One or more embodiments are now described with reference to the drawings, wherein like reference numerals are used to refer to like elements throughout. In the following description, for purposes of explanation, numerous specific details are set forth in order to provide a thorough understanding of the various embodiments. It may be evident, however, that the various embodiments can be practiced without these specific details, e.g., without applying to any particular networked environment or standard. In other instances, well-known structures and devices are shown in block diagram form in order to facilitate describing the embodiments in additional detail.

Example embodiments are directed to resumable ordered recursive traversal of an unordered directory tree. Using the techniques described herein, a lexicographic listing of stored objects can be efficiently generated from a directory tree that is not lexicographically ordered. Furthermore, the techniques provided herein can output an initial partial lexicographic listing of stored objects having a start location and an end location, and the techniques can subsequently resume to output a subsequent lexicographic listing of stored objects which begins after the end location.

One example computing platform that can optionally incorporate the techniques disclosed herein is an ISILON OneFS® cluster provided by DELL®, Inc. It can be appreciated that OneFS® clusters are one of many optional object storage technologies, any of which can incorporate the teachings of this disclosure.

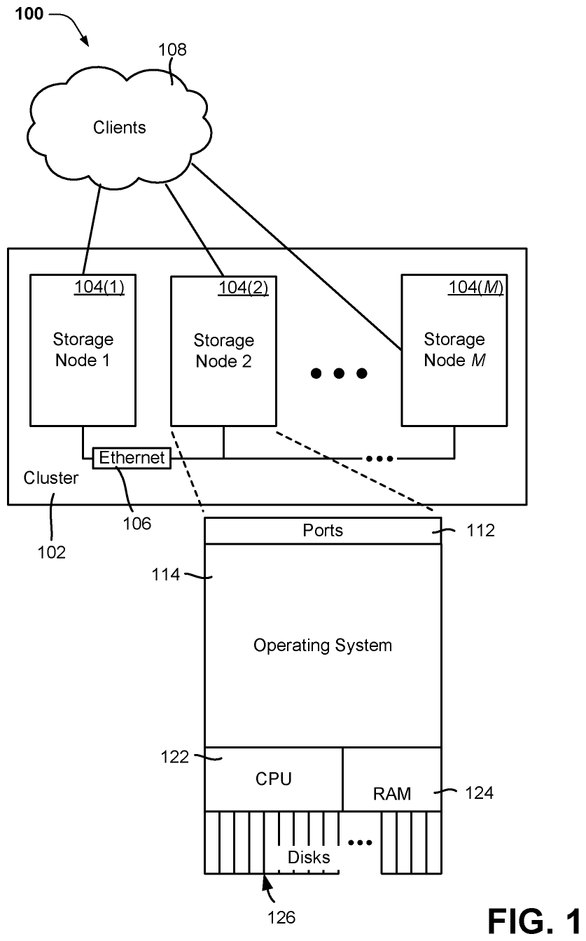

FIG. 1 illustrates an example cluster of computing devices, in accordance with one or more embodiments described herein. FIG. 1 includes a cluster 102 of data node devices, referred to in FIG. 1 as storage nodes 104(1), 104(2) . . . 104(M). Each storage node 104(1), 104(2) . . . 104(M) can comprise a computing device. Storage nodes 104(1), 104(2) . . . 104(M) can be configured to serve objects in response to requests from clients 108. Furthermore, typically one of the nodes 104(1), 104(2) . . . 104(M) can host a cluster controller virtual machine (not shown in FIG. 1), making that node the cluster controller node which administers the cluster 102. The nodes 104(1), 104(2) . . . 104(M) can be coupled to each other via a suitable data communications link comprising interfaces and protocols such as, but not limited to, Ethernet block 106.

Clients 108 can send data system-related requests to the cluster 102, which in general can be configured as one large object namespace. The cluster 102 can maintain an unlimited number of objects, e.g., up to trillions of objects or more. To this end, a node such as the node 104(2) generally comprises ports 112 by which clients 108 connect to the cluster 102. Example ports 112 are provided for requests via various protocols, including but not limited to SMB (server message block), FTP (file transfer protocol), HTTP/HTTPS (hypertext transfer protocol), and NFS (Network File System); further, SSH (secure shell) allows administration-related requests, for example.

Each node, such as the node 104(2), can include an instance of an operating system 114, e.g., a OneFS® or other operating system. Each node, such as the node 104(2), can furthermore include a CPU 122, RAM 124, and storage devices such as disks 126. RAM 124 and disks 126 can comprise, e.g., volatile memory, nonvolatile memory, hard disk drives, solid-state drives or other types of memory devices. Furthermore, RAM 124 and disks 126 at multiple of the storage nodes 104(1)-104(M), as well as other storage devices attached to the cluster 102, can be used to collectively support a logical disk which provides a shared storage location for the cluster 102.

It should be emphasized that cluster deployments can be of any size. Depending on the needs of a particular organization, some clusters may comprise five or fewer nodes, while large clusters can comprise much larger numbers of nodes. The technologies disclosed herein can be included in clusters of any size, as can be appreciated.

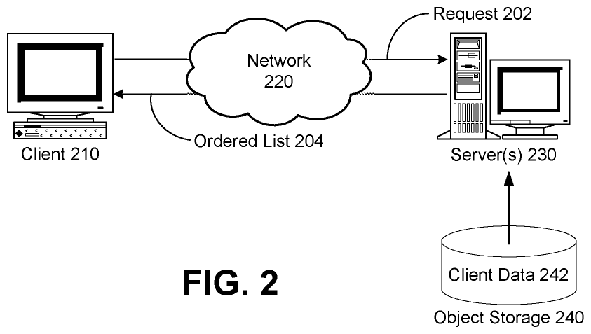

FIG. 2 illustrates an example client and server coupled via a network, in accordance with one or more embodiments described herein. FIG. 2 comprises a client 210, a network 220, server(s) 230, and an object storage 240 comprising client data 242. In some embodiments, the client 210 can comprise, e.g., a client among clients 108 introduced in FIG. 1, the server(s) 230 can comprise, e.g., a cluster 102 introduced in FIG. 1, and object storage 240 can comprise, e.g., RAM 124 and disks 126 introduced in FIG. 1.

In FIG. 2, the client 210 sends a request 202 to server(s) 230. The request 202 can comprise a request for an ordered list of objects stored in client data 242. In response to the request 202, the server(s) 230 can build the ordered list 204 using the techniques described herein. The server(s) 230 can return the ordered list 204 to the client 210.

In some embodiments, the server(s) 230 can provide storage for many different clients, including client 210. The object storage 240 can include client data 242 associated with client 210, as well as other client data not shown in FIG. 2, which may be associated with other clients. Server(s) 230 and object storage 240 can separately store and process client data associated with different clients, e.g., in different “buckets” which can be associated with the different clients. When any client, e.g., client 210, sends a request 202, the server(s) 230 can optionally generate an ordered list 204 that includes only objects associated with the requesting client 210.

The client 210 is represented in FIG. 2 as a single client device, however, in some embodiments, the client can comprise a person or business equipped to use any of multiple client devices. The client 210 can comprise any client device equipped with appropriate credentials to access client data 242. The network 220 can include, e.g., the Internet or any other communications network, and the server(s) 230 can optionally comprise multiple interconnected servers, optionally in multiple different geographic locations. Likewise, the object storage 240 can comprise multiple storage media which may be physically located at multiple different geographic locations. Client data 242 may be referred to herein as client objects. The term “object” as used herein refers to any discrete data item, e.g., a file.

In some embodiments, as described further in connection with subsequent figures, the client data 242 can comprise a directory tree that stores client objects in various directories and nested subdirectories. The client data 242 can optionally include a large number of client objects. For example, the client data 242 can include up to thousands, hundreds of thousands, millions or more client objects. The request 202 can request an ordered list 204 of client objects, in an order other than the order included in the directory tree. For example, the request 202 can request a lexicographically ordered list of objects, while the client data 242 is not lexicographically ordered. Embodiments of this disclosure provide techniques to efficiently build, by server(s) 230, an ordered list 204 in response to a request 202.

In some embodiments, techniques according to this disclosure can build an ordered list 204 comprising a relevant portion of client objects stored among client data 242, where the relevant portion begins at a starting location specified in the request 202. Furthermore, techniques according to this disclosure can be resumed to subsequently provide a next relevant portion of client objects stored among client data 242, where the next relevant portion begins at an end location of a previously provided ordered list 204.

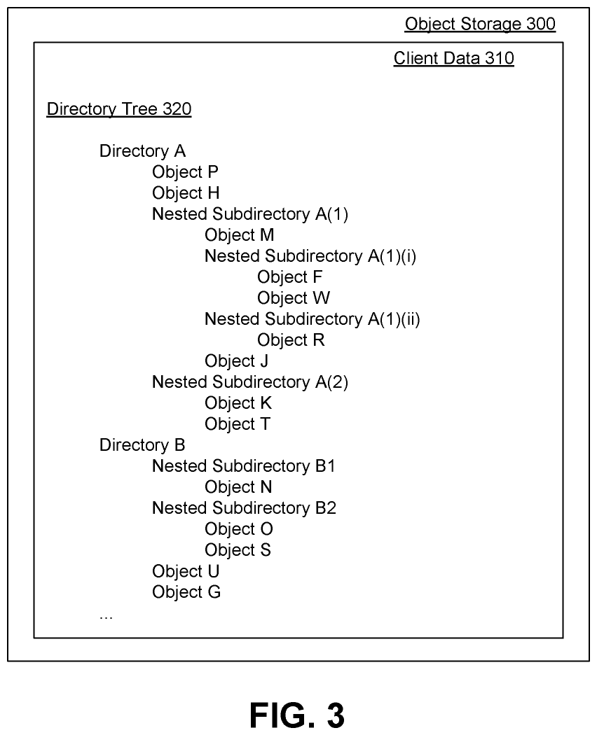

FIG. 3 illustrates an example object storage comprising an example directory tree, in accordance with one or more embodiments described herein. The object storage 300 can optionally comprise client data associated with multiple different clients, and client data 310 represents the client data of one such client. Client data 310 comprises a directory tree 320 which can include, e.g., objects stored on behalf of the client, wherein the objects are included in various directories and nested subdirectories of the directory tree 320. In some embodiments, the object storage 300 can comprise storage at a cluster of data node devices, such as the cluster 102 illustrated in FIG. 1, or the object storage 300 can comprise an object storage such as object storage 240 illustrated in FIG. 2.

In the example provided by FIG. 3, the directory tree 320 comprises an example tree structure. It will be appreciated that the example tree structure is just one of an infinite variety of tree structures and this disclosure is applicable to any directory tree structure. Directory tree 320 comprises Directory A and Directory B. Directories A and B each include one or more objects and/or nested subdirectories, and the nested subdirectories can include further objects and nested subdirectories. In the illustrated example, Directory A includes Object P, Object H, Nested Subdirectory A(1), and Nested Subdirectory A(2). Nested Subdirectory A(1) includes Object M, Nested Subdirectory A(1)(i), Nested Subdirectory A(1)(ii), and Object J. Nested Subdirectory A(1)(i) includes Object F and Object W. Nested Subdirectory A(1)(ii) includes Object R. Meanwhile, Nested Subdirectory A(2) includes Object K and Object T.

Directory B includes Nested Subdirectory B(1), Nested Subdirectory B(2), Object U, and Object G. Nested Subdirectory B(1) includes Object N. Nested Subdirectory B(2) includes Object O and Object S. The ellipsis under Object G indicates that the directory tree 320 can include further directories, nested subdirectories and objects, according to any directory tree structure.

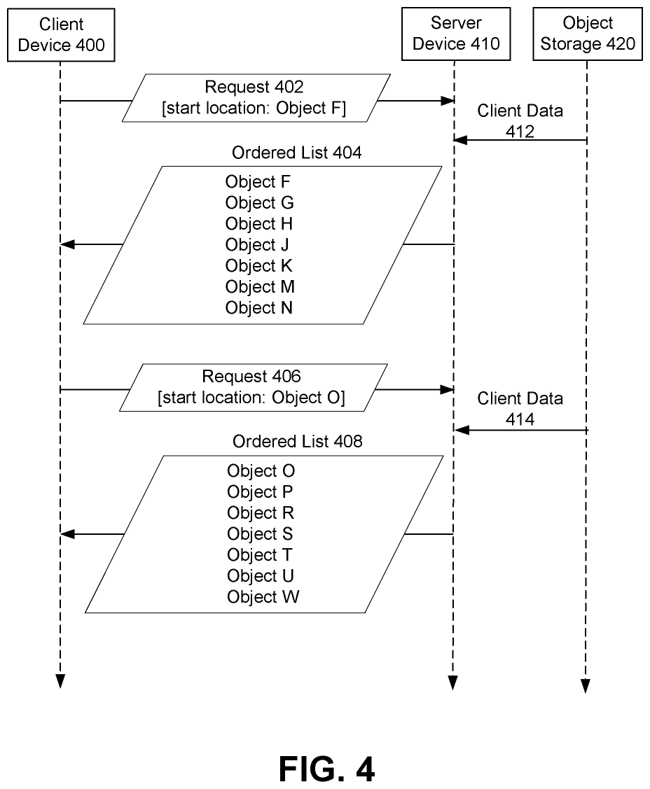

Embodiments of this disclosure can process a directory tree such as directory tree 320 to output ordered lists which list portions of the client objects stored in the directory tree 320. For example, a server device 410, illustrated in FIG. 4, can use the techniques provided herein to process the directory tree 320, and the server device 410 can thereby produce an ordered list 404 and/or an ordered list 408, also illustrated in FIG. 4. The ordered lists 404, 408 comprise the objects in the directory tree 320 in lexicographical order.

FIG. 4 illustrates example interactions between a client device, a server device and an object storage, in accordance with one or more embodiments described herein. FIG. 4 illustrates interactions between a client device 400, a server device 410, and an object storage 420. The client device can comprise, e.g., a client 210 such as introduced in FIG. 2. The server device 410 can comprise, e.g., a server among server(s) 230 introduced in FIG. 2. The object storage 420 can comprise, e.g., an object storage 240 introduced in FIG. 2.

The illustrated interactions include sending, by the client device 400, a first request 402 to the server device 410, and receiving, at the server device 410, the first request 402. The first request 402 can comprise a request for an ordered list of client objects stored at object storage 420. The first request 402 can comprise a start location, such as Object F, or any other desired start location for the requested ordered list.

In response to the first request 402, the server device 410 can read client data 412 from the object storage 420. The server device 410 can read and process client data 412 using the techniques described herein to build a first ordered list 404. As shown in FIG. 4, the ordered list 404 comprises a fixed number of client objects in lexicographical order. Furthermore, the ordered list 404 starts at the start location (Object F) specified in the first request 402. The example ordered list 404 is based on processing the example directory tree 320 illustrated in FIG. 3. The server device 410 can send the ordered list 404 to the client device 400, and the client device 400 can receive the ordered list 404.

The illustrated interactions furthermore include sending, by the client device 400, a second request 406 to the server device 410, and receiving, at the server device 410, the second request 406. The second request 406 can comprise a request for a next ordered list of client objects stored at object storage 420. The second request 406 can comprise a start location, such as Object 0, which falls at or after an end location of the previous ordered list 404. Alternatively, the second request 406 can comprise any other desired start location.

In response to the second request 406, the server device 410 can read client data 414 from the object storage 420. The server device 410 can read and process client data 414 using the techniques described herein to build a second ordered list 408. As shown in FIG. 4, the ordered list 408 comprises a fixed number of client objects in lexicographical order. Furthermore, the ordered list 408 starts at the start location (Object O) specified in the second request 406. The example ordered list 408 is based on processing the example directory tree 320 illustrated in FIG. 3. The server device 410 can send the ordered list 408 to the client device 400, and the client device 400 can receive the ordered list 408.

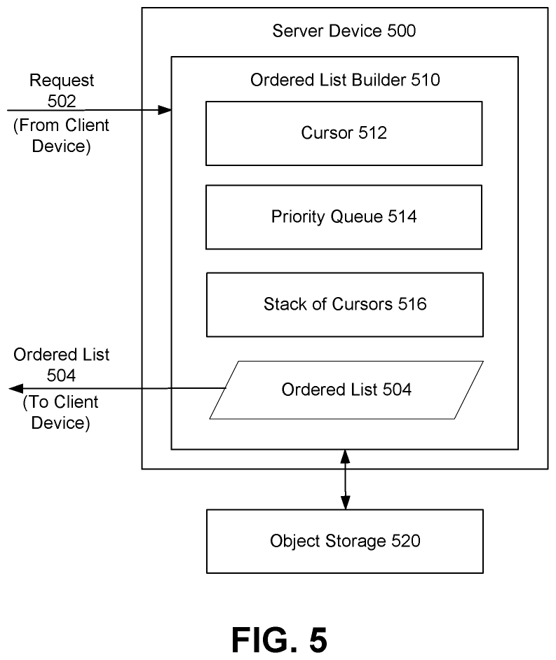

FIG. 5 illustrates example operations of a server device to build an ordered list, in accordance with one or more embodiments described herein. FIG. 5 comprises a server device 500 and an object storage 520. The server device 500 can comprise, e.g., a server device among the server(s) 230 illustrated in FIG. 2, and the object storage 520 can comprise, e.g., an object storage 240 such as illustrated in FIG. 2. In the illustrated example implementation, server device 500 includes an ordered list builder 510 configured to receive a request 502 from a client device, build an ordered list 504 in response to the request 502, and send the ordered list 504 to the client device. The request 502 is an example of a request 202 illustrated in FIG. 2, and the ordered list 504 is an example of an ordered list 204 illustrated in FIG. 2.

In an example implementation, the ordered list builder 510 can process the request 502 and the ordered list builder 510 can use data structures to track state for the request 502. The data structures included in the illustrated embodiment are cursor 512, priority queue 514, and stack of cursors 516.

A problem for ordered list builder 510 is, queries such as request 502, which request a list of objects in a sub-tree in lexicographical order, can't exploit the ordering of a directory tree in object storage 520 if the directory tree is not lexicographically ordered. Embodiments of this disclosure can apply a method for recursive lexicographic listing with space complexity bounded by the size of the result, independent of the size of the sub-tree of possible matches.

Furthermore, techniques presented herein are resumable after fail-over. This is accomplished by building a stack of arrays of intermediate results, where the size of the stack and the arrays can be bounded by size of the result. An advantage of the disclosed techniques compared to other possible solutions is, the disclosed techniques work well even when a node fails and a client connects to another node for a next request. The disclosed techniques allow for building an index on more than one node simultaneously.

Object storage protocols can provide a namespace mapping keys to values without the structure of a fixed separator. Non-lexicographic ordering of cross-protocol file systems optimizes the efficiency of case sensitive and case insensitive look ups under different encodings, but is generally not exploitable for lexicographic listing.

To recursively traverse client data, e.g., data in a client “bucket” within object storage 520, a client device can send a list objects request, such as request 502, with information about the starting point of the traversal, such as a key or continuation token. The desired response is the head of the sorted recursive listing starting from the key indicated. The server 500 can use data structures to track the state for the request 502. These include cursor 512, priority queue 514, and stack of cursors 516.

The cursor 512 can track an incremental, flat walk through a directory in object storage 520 by storing an array of the head of sorted siblings within that directory, along with a constant amount of other metadata. The priority queue 514 can comprise a fixed size priority queue which builds the sorted array of the cursor 512 by admitting only entries which are ordered after the last key in the result, and before the maximum key in the priority queue 514. The stack of cursors 516 can track the overall iteration of the sub-tree. This enables resuming from any parent directory efficiently.

In an example embodiment, the ordered list builder 510 can build a lexicographically ordered list 504, in response to request 502, as follows. The ordered list builder 510 can start from the root and populate the cursor 512 of the root using a scanning method and the priority queue 514. The files before the first directory in the cursor 512 can be added to the ordered list 504, and the ordered list builder 510 can recursively process the directory. After the ordered list 504 is full, or if there are no more matches, the ordered list builder 510 can stop, and the ordered list 504 can be sent to the client device.

In some embodiments, a prefix can be supplied, e.g., by the client device, to limit the matches, and the root of the search can be chosen to be the smallest sub-tree which contains all potential results. Files which do not match the prefix can be filtered out in the scan which builds the cursor 512.

In some embodiments, a maximum number of entries in the ordered list 504 can be bounded by a constant, N. While embodiments can use any value for N, some examples can set N at, e.g., 1000 entries, or at any number of entries between 100 and 10,000 entries. Furthermore, a maximum depth of the traversal can be bounded by a maximum path length which is a constant, P. Each cursor 512 can store up to K entries, each of which can be bounded by the path length P. The stack of cursors can be bounded by the maximum depth which is also bounded by the path length P. While embodiments can use any value for P, some examples can set P at, e.g., 100 characters, or at any number of characters between 20 and 1000. The value of P in some embodiments can be constrained by an Application Programming Interface (API) or file system in use in connection with object storage 520.

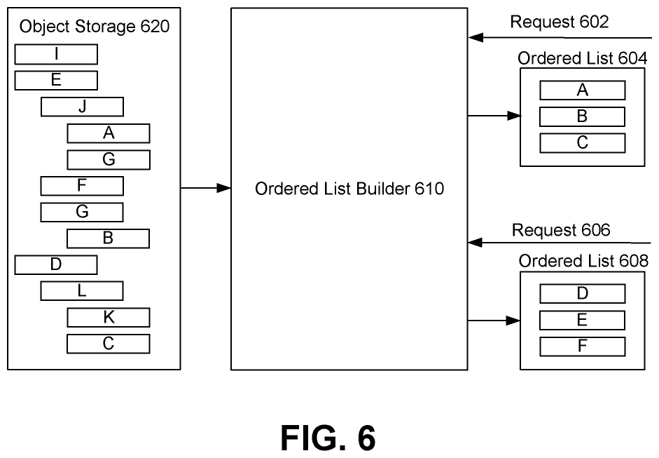

FIG. 6 illustrates example inputs and outputs of an ordered list builder, in accordance with one or more embodiments described herein. FIG. 6 includes an ordered list builder 610, which is an example of an ordered list builder 510 introduced in FIG. 5. The ordered list builder 610 receives requests 602, 606 and generates ordered lists 604, 608 in response to the requests 602, 606. The ordered list builder 610 uses the data stored in a directory tree in object storage 620 to generate the ordered lists 604, 608.

In an example, a first request 602 can indicate a starting location at object A, and the ordered list builder 610 can be configured to generate an ordered list comprising a maximum of three entries. Using the techniques and data structures described in connection with FIG. 5, the ordered list builder 610 can generate, from the directory tree in object storage 620, a first ordered list 604 which includes the maximum number of entries and starts at object A.

Using the techniques described herein, the ordered list builder 610 need not build a full ordered list comprising all objects in the object storage 620. Instead, the ordered list builder 610 can generate a “head” data structure which is ordered list 604, without ordering all the objects in object storage 620. The ordered list builder 610 can then output the ordered list 604 in response to request 602. The ordered list builder 610 need not do the work of generating ordered list 608 until after the ordered list builder 610 receives request 606.

A second request 606 can indicate a starting location at object D, and the ordered list builder 610 can remain configured to generate ordered lists comprising the maximum of three entries. Using the techniques and data structures described in connection with FIG. 5, the ordered list builder 610 can generate, from the directory tree in object storage 620, a second ordered list 608 which includes the maximum number of entries and starts at object D.

As with generating the first ordered list 604, when building the second ordered list 608, the ordered list builder 610 need not build a full ordered list comprising all objects in the object storage 620. Instead, the ordered list builder 610 can generate another “head” data structure which is ordered list 608, without ordering all the objects in object storage 620. The ordered list builder 610 can then output the ordered list 608 in response to request 606.

The ordered list builder 610 can be resumable, because it can resume after fail over or resume from an end location in a previously generated ordered list. For example, ordered list builder 610 can resume, in response to request 606, an ordered list begun with ordered list 604. Ordered list builder 610 can build ordered list 608 which has a start location specified in request 606 and representing an entry immediately after the end location of the previous ordered list 604.

Furthermore, the ordered list builder 610 can operate recursively, as described in connection with FIG. 5. The ordered list builder 610 operates recursively in the manner that it scans for client objects stored in different directories and subdirectories of a directory tree. Upon encountering a nested subdirectory, the ordered list builder 610 can enter and scan the nested subdirectory similarly to the manner in which any parent level directories are opened and scanned.

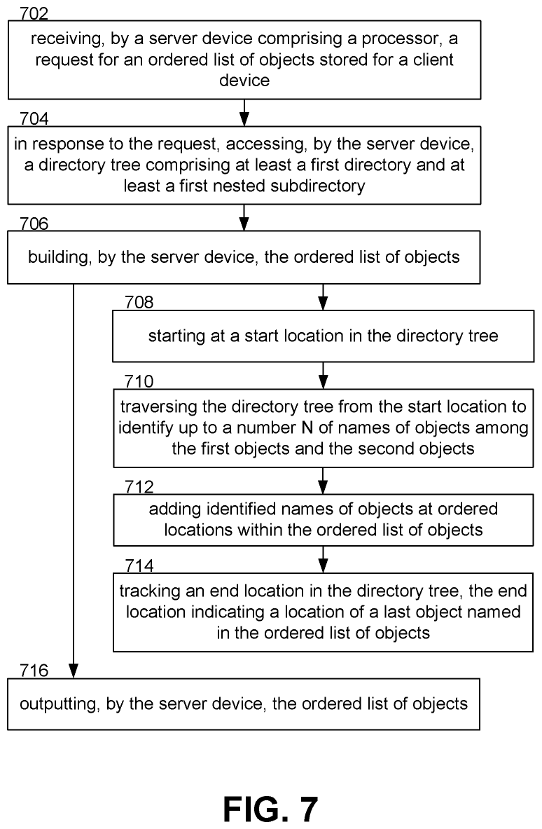

FIG. 7 is a flow diagram of an example, non-limiting computer implemented method for a server device to build an ordered list of objects from an unordered directory tree, in accordance with one or more embodiments described herein. The blocks of the illustrated method represent operations according to a method, components in one or more computing devices, and/or computer executable instructions in a computer readable storage medium, as can be appreciated. While the operations are illustrated in sequence, it can furthermore be appreciated that certain operations can optionally be re-ordered, combined, removed or supplemented with other operations in some embodiments.

In an embodiment, the method illustrated in FIG. 7 can be performed by one or more server devices, such as server(s) 230 illustrated in FIG. 2. The server(s) 230 can be equipped to access an object storage, e.g., object storage 240, and the server(s) 230 can comprise an ordered list builder such as ordered list builder 510 or 610. At 702, a server device of the server(s) 230 can be configured to receive a request for an ordered list of objects stored for a client device. For example, the server(s) 230 can receive a request 202. The request 202 can comprise a request for and ordered list of objects stored in the object storage 240 for a client 210. However, the objects stored in the object storage 240 can be stored, e.g., in a directory tree, and not in an order designated or implicit in the request 202. For example, the request 202 can request a lexicographically ordered list of objects, while the objects in the object storage 240 are not lexicographically ordered. In some embodiments, the request 202 for the ordered list of objects can comprise a limiting parameter, e.g. a prefix as described in connection with FIG. 5.

At 704, in response to the request 202, the server(s) 230 can be configured to access a directory tree comprising at least a first directory and at least a first nested subdirectory. An example directory tree 320 is illustrated in FIG. 3. The directory tree 320 comprises, e.g., a first directory (Directory A) and a first nested subdirectory (Nested Subdirectory A(1)). The first directory (Directory A) comprises first objects of the objects stored for the client device. For example, Directory A comprises first objects P and H. The first nested subdirectory (Nested Subdirectory A(1)) is nested within the first directory (Directory A), and the first nested subdirectory comprises second objects of the objects stored for the client device. For example, Nested Subdirectory A(1) comprises second objects M and J.

At 706, the server(s) 230 can be configured to build the ordered list of objects. For example, with reference to FIG. 2, the server(s) 230 can build the ordered list 204 in response to the request 202. Operation 706 can comprise several elements, illustrated as operations 708, 710, 712, and 714 in FIG. 7. Operations 708, 710, 712, and 714 can be performed for example by an ordered list builder 510 or 610, as illustrated in FIG. 5 and FIG. 6. In an embodiment, the ordered list builder 510 or 610 can be implemented, e.g., via software that executes at server(s) 230. Thus the operations of the ordered list builder 510 or 610 can be described as operations of the server(s) 230.

At 708, the server(s) 230 can be configured to start at a start location in the directory tree. In an embodiment such as illustrated in FIG. 4, the start location can be specified in the request, e.g., in request 402. The start location can specify, e.g., an object name of an object at the beginning of the requested ordered list 404. As shown in request 406, in some instances the start location (Object O) can comprise, or be based on, a previous end location (Object N) associated with a previous ordered list 404.

At 710, the server(s) 230 can be configured to traverse the directory tree from the start location to identify up to a number N of names of objects among the first objects and the second objects. Using the directory tree 320 in FIG. 3 as an example, the server(s) 230 can traverse the directory tree 320 from the start location by scanning the object names in the directory tree 320. The server(s) 230 can identify up to a number N of names of objects among the first objects and the second objects, noting that multiple directories and nested subdirectories may be scanned to reach the total number N of names. Traversing the directory tree 320 from the start location can comprise recursively traversing at least one nested subdirectory of the directory tree 320.

At 712, the server(s) 230 can be configured to add identified names of objects at ordered locations within the ordered list of objects. For example, as the server(s) 230 are traversing the directory tree 320 according to operation 710, the server(s) 230 can add identified names of objects at ordered locations within an ordered list of objects such as ordered list 404. Adding the identified names of objects at ordered locations can comprise, e.g., inserting an object name into ordered list 404 at an appropriate location according to the order, e.g., the lexicographic order, of the request 402. Adding the identified names of objects at the ordered locations within the ordered list 404 can comprise adding the identified names of objects at lexicographically ordered locations within the ordered list 404. In embodiments wherein a request, e.g., request 402, comprises a limiting parameter, e.g. a prefix as described in connection with FIG. 5, adding the identified names of objects at ordered locations within the ordered list 404 can comprise adding only identified names of objects that match the limiting parameter.

At 714, the server(s) 230 can be configured to track an end location in the directory tree, the end location indicating a location of a last object named in the ordered list of objects. Tracking the end location in the directory tree can comprise maintaining a stack of cursors as described in connection with FIG. 5. The stack of cursors can include, e.g., a cursor at the end location, a cursor at a nested subdirectory including the end location, and optionally other cursors at other directories including the nested subdirectory.

At 716, the server(s) 230 can be configured to output the ordered list of objects. For example, the server 410 can output the ordered list 404 in response to the request 402. The server 410 can output the ordered list 404 when the ordered list 404 reaches its designated number N of names of objects, or, alternatively, before the ordered list 404 reaches its designated number N of names of objects if there are no further objects to add to the ordered list 404.

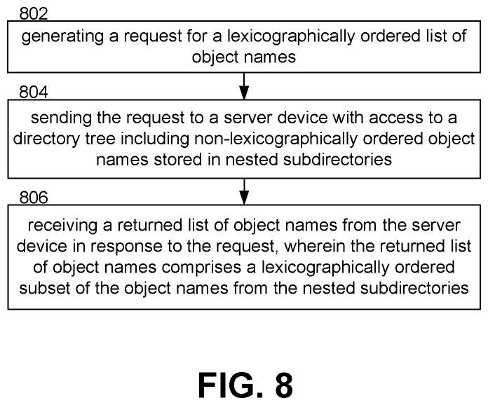

FIG. 8 is a flow diagram of an example, non-limiting computer implemented method for a client device to request an ordered list of objects from a server which stores the objects in an unordered directory tree, in accordance with one or more embodiments described herein. The blocks of the illustrated method represent operations according to a method, components in one or more computing devices, and/or computer executable instructions in a computer readable storage medium, as can be appreciated. While the operations are illustrated in sequence, it can furthermore be appreciated that certain operations can optionally be re-ordered, combined, removed or supplemented with other operations in some embodiments.

In an embodiment, the method illustrated in FIG. 8 can be performed by a client device, such as client 210 in FIG. 2. At 802, the client device 202 can be configured to generate a request 202 for a lexicographically ordered list of object names. The request 202 can optionally identify a start location in a directory tree, e.g. an object name to use as a start location. In some embodiments, the request 202 can comprise a key or a token which includes the start location. The start location can be based on a previous end location associated with a previous returned list of object names received from a server device among server(s) 230. In some embodiments, the request 202 can comprise a limiting parameter.

At 804, the client device 210 can be configured to send the request 202 to a server device. For example, client device 210 can send the request 202 to a server device among server device(s) 230. The server device can be equipped with access to a directory tree, e.g., in client data 242, and the directory tree can include non-lexicographically ordered object names stored in nested subdirectories.

At 806, the client device 210 can be configured to receive a returned list of object names, such as ordered list 204, from the server device in response to the request 202. The returned list of object names can comprise a lexicographically ordered subset of the object names from the nested subdirectories stored in client data 242. When the request 202 includes a start location, the returned list of object names, e.g., ordered list 204, can comprise only object names occurring under the start location in the directory tree. The phrase “under the start location” as used herein refers to having an order position after the start location. When the request 202 includes a limiting parameter, the returned list of object names can optionally comprise only object names that include the limiting parameter. The returned lexicographically ordered subset of the object names can include a predetermined number of object names, e.g., between 100 and 5000 object names in some embodiments.

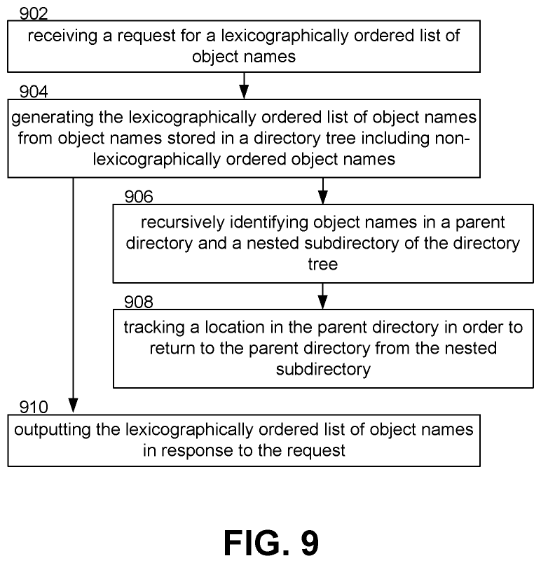

FIG. 9 is a flow diagram of another example, non-limiting computer implemented method for a server device to build an ordered list of objects from an unordered directory tree, in accordance with one or more embodiments described herein. The blocks of the illustrated method represent operations according to a method, components in a computing device, and/or computer executable instructions in a computer readable storage medium, as can be appreciated. While the operations are illustrated in sequence, it can furthermore be appreciated that certain operations can optionally be re-ordered, combined, removed or supplemented with other operations in some embodiments.

In an embodiment, the method illustrated in FIG. 9 can be performed by one or more server devices, such as server(s) 230 illustrated in FIG. 2. The server(s) 230 can be equipped to access an object storage, e.g., object storage 240, and the server(s) 230 can comprise an ordered list builder such as ordered list builder 510 or 610. At 902, a server device of the server(s) 230 can be configured to receive a request 202 for a lexicographically ordered list of object names. The request 202 can comprise a client 210 request for names of objects stored on behalf of a client 210. In some embodiments, the server(s) 230 can access object storage 240 to build the ordered list 204 in response to the request 202. The object storage 240 can include, e.g., a directory tree in client data 242, wherein the directory tree includes only the object names stored on behalf of the client 210. In some embodiments, the request 202 can comprise a limiting parameter.

At 904, the server(s) 230 can be configured to generate the lexicographically ordered list 204 of object names from object names stored in a directory tree including non-lexicographically ordered object names. In other words, server(s) 230 can generate the lexicographically ordered list 204 from object names stored in the directory tree in client data 242. The lexicographically ordered list 204 of object names can include, e.g., a subset of the object names stored in the directory tree. The subset can comprise a predetermined total number of object names.

Operation 904 can include operations 906 and 908. At 906, the server(s) 230 can be configured to recursively identify object names in a parent directory and a nested subdirectory of the directory tree. Here, a parent directory and a nested subdirectory of the directory tree can include multiple parent directories and nested subdirectories. A cursor and a priority queue can optionally be used to build a sorted array of object names, as described in connection with FIG. 5. At 908, the server(s) 230 can be configured to track a location in the parent directory in order to return to the parent directory from the nested subdirectory. A cursor or stack of cursors can be used to track the location in the parent directory, which facilitates resuming to build subsequent ordered lists.

To handle requests comprising limiting parameters, generating the lexicographically ordered list of object names at operation 904 can comprise adding only object names that include the limiting parameter to the lexicographically ordered list of object names. At 910, the server(s) 230 can be configured to output the lexicographically ordered list of object names, e.g., ordered list 204, in response to the request 202.

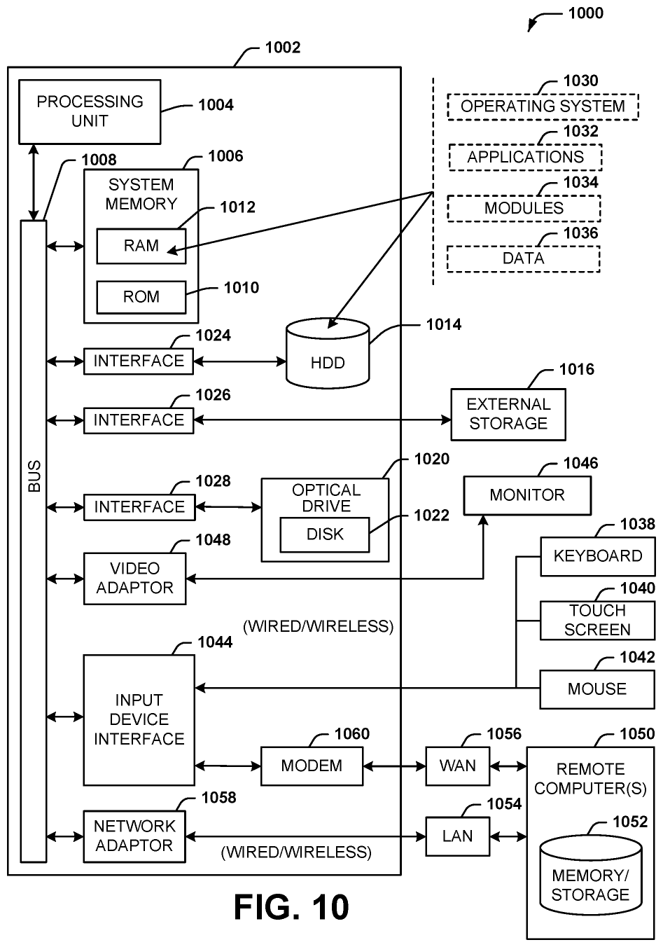

In order to provide additional context for various embodiments described herein, FIG. 10 and the following discussion are intended to provide a brief, general description of a suitable computing environment 1000 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, IoT devices, distributed computing systems, as well as personal computers, hand-held computing devices, microprocessor-based or programmable consumer electronics, and the like, each of which can be operatively coupled to one or more associated devices.

The embodiments illustrated herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 10, the example environment 1000 for implementing various embodiments of the aspects described herein includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors and may include a cache memory. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes ROM 1010 and RAM 1012. A basic input/output system (BIOS) can be stored in a non-volatile memory such as ROM, erasable programmable read only memory (EPROM), EEPROM, which BIOS contains the basic routines that help to transfer information between elements within the computer 1002, such as during startup. The RAM 1012 can also include a high-speed RAM such as static RAM for caching data.

The computer 1002 further includes an internal hard disk drive (HDD) 1014 (e.g., EIDE, SATA), one or more external storage devices 1016 (e.g., a magnetic floppy disk drive (FDD) 1016, a memory stick or flash drive reader, a memory card reader, etc.) and an optical disk drive 1020 (e.g., which can read or write from a CD-ROM disc, a DVD, a BD, etc.). While the internal HDD 1014 is illustrated as located within the computer 1002, the internal HDD 1014 can also be configured for external use in a suitable chassis (not shown). Additionally, while not shown in environment 1000, a solid state drive (SSD) could be used in addition to, or in place of, an HDD 1014. The HDD 1014, external storage device(s) 1016 and optical disk drive 1020 can be connected to the system bus 1008 by an HDD interface 1024, an external storage interface 1026 and an optical drive interface 1028, respectively. The interface 1024 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1002, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. The systems and methods described herein can be implemented utilizing various commercially available operating systems or combinations of operating systems.

Computer 1002 can optionally comprise emulation technologies. For example, a hypervisor (not shown) or other intermediary can emulate a hardware environment for operating system 1030, and the emulated hardware can optionally be different from the hardware illustrated in FIG. 10. In such an embodiment, operating system 1030 can comprise one virtual machine (VM) of multiple VMs hosted at computer 1002. Furthermore, operating system 1030 can provide runtime environments, such as the Java runtime environment or the .NET framework, for applications 1032. Runtime environments are consistent execution environments that allow applications 1032 to run on any operating system that includes the runtime environment. Similarly, operating system 1030 can support containers, and applications 1032 can be in the form of containers, which are lightweight, standalone, executable packages of software that include, e.g., code, runtime, system tools, system libraries and settings for an application.

Further, computer 1002 can comprise a security module, such as a trusted processing module (TPM). For instance with a TPM, boot components hash next in time boot components, and wait for a match of results to secured values, before loading a next boot component. This process can take place at any layer in the code execution stack of computer 1002, e.g., applied at the application execution level or at the operating system (OS) kernel level, thereby enabling security at any level of code execution.

A user can enter commands and information into the computer 1002 through one or more wired/wireless input devices, e.g., a keyboard 1038, a touch screen 1040, and a pointing device, such as a mouse 1042. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1004 through an input device interface 1044 that can be coupled to the system bus 1008, but can be connected by other interfaces, such as a parallel port, an IEEE 1394 serial port, a game port, a USB port, an IR interface, a BLUETOOTH® interface, etc.

A monitor 1046 or other type of display device can be also connected to the system bus 1008 via an interface, such as a video adapter 1048. In addition to the monitor 1046, a computer typically includes other peripheral output devices (not shown), such as speakers, printers, etc.

The computer 1002 can operate in a networked environment using logical connections via wired and/or wireless communications to one or more remote computers, such as a remote computer(s) 1050. The remote computer(s) 1050 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1052 is illustrated. The logical connections depicted include wired/wireless connectivity to a local area network (LAN) 1054 and/or larger networks, e.g., a wide area network (WAN) 1056. Such LAN and WAN networking environments are commonplace in offices and companies, and facilitate enterprise-wide computer networks, such as intranets, all of which can connect to a global communications network, e.g., the internet.

When used in a LAN networking environment, the computer 1002 can be connected to the local network 1054 through a wired and/or wireless communication network interface or adapter 1058. The adapter 1058 can facilitate wired or wireless communication to the LAN 1054, which can also include a wireless access point (AP) disposed thereon for communicating with the adapter 1058 in a wireless mode.

When used in a WAN networking environment, the computer 1002 can include a modem 1060 or can be connected to a communications server on the WAN 1056 via other means for establishing communications over the WAN 1056, such as by way of the internet. The modem 1060, which can be internal or external and a wired or wireless device, can be connected to the system bus 1008 via the input device interface 1044. In a networked environment, program modules depicted relative to the computer 1002 or portions thereof, can be stored in the remote memory/storage device 1052. It will be appreciated that the network connections shown are example and other means of establishing a communications link between the computers can be used.

When used in either a LAN or WAN networking environment, the computer 1002 can access cloud storage systems or other network-based storage systems in addition to, or in place of, external storage devices 1016 as described above. Generally, a connection between the computer 1002 and a cloud storage system can be established over a LAN 1054 or WAN 1056 e.g., by the adapter 1058 or modem 1060, respectively. Upon connecting the computer 1002 to an associated cloud storage system, the external storage interface 1026 can, with the aid of the adapter 1058 and/or modem 1060, manage storage provided by the cloud storage system as it would other types of external storage. For instance, the external storage interface 1026 can be configured to provide access to cloud storage sources as if those sources were physically connected to the computer 1002.

The computer 1002 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

The above description includes non-limiting examples of the various embodiments. It is, of course, not possible to describe every conceivable combination of components or methodologies for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

With regard to the various functions performed by the above described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature may be combined with one or more other features of the other implementations as may be desired and advantageous for any given or particular application.

The terms “exemplary” and/or “demonstrative” as used herein are intended to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A method, comprising:
receiving, by a server device comprising a processor, a request for an ordered list of objects stored for a client device;
in response to the request, accessing, by the server device, a directory tree comprising at least a first directory and at least a first nested subdirectory, wherein:
the first directory comprises first objects of the objects stored for the client device;
the first nested subdirectory is nested within the first directory; and
the first nested subdirectory comprises second objects of the objects stored for the client device; and
building, by the server device, the ordered list of objects, wherein building the ordered list of objects comprises:
starting at a start location in the directory tree;
traversing the directory tree from the start location to identify up to a number N of names of objects among the first objects and the second objects;
adding identified names of objects at ordered locations within the ordered list of objects; and
tracking an end location in the directory tree, the end location indicating a location of a last object named in the ordered list of objects; and
outputting, by the server device, the ordered list of objects.

2. The method of claim 1, wherein the ordered list of objects is lexicographically ordered, and wherein adding the identified names of objects at the ordered locations within the ordered list of objects comprises adding the identified names of objects at lexicographically ordered locations within the ordered list of objects.

3. The method of claim 1, wherein traversing the directory tree from the start location comprises recursively traversing at least one nested subdirectory of the directory tree.

4. The method of claim 1, wherein the start location is specified in the request for the ordered list of objects stored for the client device.

5. The method of claim 1, wherein the start location is based on a previous end location associated with a previous ordered list of objects.

6. The method of claim 1, wherein tracking the end location in the directory tree comprises maintaining a stack of cursors, the stack of cursors including a cursor at the end location and a cursor at a nested subdirectory including the end location.

7. The method of claim 1, wherein the request for the ordered list of objects comprises a limiting parameter, and wherein adding the identified names of objects at ordered locations within the ordered list of objects comprises adding only identified names of objects that match the limiting parameter.

8. A client device, comprising:
at least one processor; and
at least one memory that stores executable instructions that, when executed by the at least one processor, facilitate performance of operations, comprising:
generating a request for a lexicographically ordered list of object names;
sending the request to a server device with access to a directory tree including non-lexicographically ordered object names stored in nested subdirectories; and
receiving a returned list of object names from the server device in response to the request, wherein the returned list of object names comprises a lexicographically ordered subset of the object names from the nested subdirectories.

9. The client device of claim 8, wherein the request identifies a start location in the directory tree.

10. The client device of claim 9, wherein the start location is based on a previous end location associated with a previous returned list of object names received from the server device.

11. The client device of claim 9, wherein the returned list of object names comprises only object names occurring under the start location in the directory tree.

12. The client device of claim 9, wherein the request comprises a key or a token which includes the start location.

13. The client device of claim 8, wherein the request comprises a limiting parameter, and wherein the returned list of object names comprises only object names that include the limiting parameter.

14. The client device of claim 8, wherein the lexicographically ordered subset of the object names comprises between 100 and 5000 object names.

15. A non-transitory machine-readable medium, comprising executable instructions that, when executed by a processor, facilitate performance of operations, comprising:
receiving a request for a lexicographically ordered list of object names;
generating the lexicographically ordered list of object names from object names stored in a directory tree including non-lexicographically ordered object names, wherein the generating comprises:
recursively identifying object names in a parent directory and a nested subdirectory of the directory tree; and
tracking a location in the parent directory in order to return to the parent directory from the nested subdirectory; and
outputting the lexicographically ordered list of object names in response to the request.

16. The non-transitory machine-readable medium of claim 15, wherein the request comprises a client request for object names stored on behalf of a client, and wherein the directory tree includes only the object names stored on behalf of the client.

17. The non-transitory machine-readable medium of claim 15, wherein a cursor is used to track the location in the parent directory.

18. The non-transitory machine-readable medium of claim 15, wherein the generating the lexicographically ordered list of object names further comprises using a priority queue to build a sorted array of object names.

19. The non-transitory machine-readable medium of claim 15, wherein the request comprises a limiting parameter, and wherein the generating the lexicographically ordered list of object names comprises adding only object names that include the limiting parameter to the lexicographically ordered list of object names.

20. The non-transitory machine-readable medium of claim 15, wherein the lexicographically ordered list of object names includes a subset of the object names stored in the directory tree, and wherein the subset comprises a predetermined total number of object names.
